(19) United States
(12) Patent Application Publication
(10) Pub. No.: US 2008/0320026 A1
(43) Pub. Date: Dec. 25, 2008

(54) Method and system for managing a network-based database of user feedback

(76) Inventor: Jacqueline Linder, Palo Alto, CA (US)

Correspondence Address: LESTER H. BIRNBAUM, 6 OAKMOUNT COURT, SIMPSONVILLE, SC, 29681, US

(21) Appl. No.: 11/821,200

(22) Filed: Jun. 22, 2007

(51) Int. Cl. G06F 17/30

(52) U.S. Cl. 707/102; 707/E17.005

(57) ABSTRACT

A method for managing a network-based database is provided. The network-based database includes user feedback on various topics. The subject matter on which feedback is given is referred to as a topic. The user feedback in the database is organized into multiple categories. The method includes receiving a request from a user to create one or more categories in the database. Further, the method includes creating the one or more categories based on the request. The method also includes receiving user feedback on a topic associated with the one or more categories. Furthermore, the method includes listing the user feedback under the topic in the database.

### BACKGROUND OF THE INVENTION

The present invention relates in general to the field of collaboration and sharing of information, and more specifically, to a method and a system for managing a network-based database of user feedback.

With the rapid growth of the Internet in recent years, it is becoming increasingly cumbersome to search and identify relevant information on the Internet. This information can be in the form of product specifications, price, contact details, user feedback, and the like. To overcome this drawback, there are specific databases available on the internet, where this information is organized into various categories and sub-categories. This organization makes it convenient for users to search and identify the relevant information. For example, there are databases where user feedback on different products and/or services is organized into various categories. A user interested in a particular product and/or service can search in the relevant category to identify user feedback on the product and/or service. The user can also navigate the relevant category to view user feedback on other related products and/or services.

Some of these databases allow the users to add information to the existing database. The information added can be accessed by subsequent users. However, the users are allowed to add information related only to the categories and sub-categories into which the database is organized. For example, users can submit their feedback only on the products and/or services listed under the existing categories and sub-categories present in the database. A user cannot submit feedback on a product and/or service which is not related to the categories present in the database. Thus, users can share their views and opinions with other users only about these products and/or services.

Similarly, there exist various blogging sites, chat-forums and email groups where users can share information on a variety of topics. Users can add information, such as their comments, feedback, opinions, and the like, to a blog entry or a chat forum topic and this information can be accessed by other users. However, the information shared is limited by the format of the underlying database. These implementations collect information related to existing topics, but they do not allow this information to be organized by categories and sub-categories that are not related to these predefined topics. Email user groups enable a community of users to share information in the form of written comments on an unlimited number of topics, but they do not provide a solution for organizing this information. As a result, it is difficult for subsequent users to search and access the information. In such cases users find information from a single author at a time, and not organized information based on the collective wisdom of a group.

In light of the foregoing discussion, there is a need for a method and system for managing a network-based database that enables users to add and share information related to any possible topic. The information added to the database should be organized, making it convenient for subsequent users to search and access the information. Further, users should be allowed to modify the organization of the database, if the information they wish to share is not associated with the existing organization of the database.

### SUMMARY

The present invention describes a method for managing a network-based database. In an embodiment, the network-based database includes user feedback given by different users on various topics. The subject matter on which this user feedback is given is referred to as a topic. The user feedback in the database is organized into various categories and sub-categories, based on certain attributes of the topics, such as its geographical location, content, and the like. The method described in one of the embodiments of the invention includes receiving a request from a user to create one or more categories in the database. Further, the method includes creating one or more categories based on the request. Furthermore, the method includes receiving a user feedback on a topic associated with the one or more categories. Moreover, the method includes listing the user feedback under the topic in the database.

Thus, the present invention provides users with a method for submitting feedback on any topic to the network-based database. If the topic on which users desire to submit feedback is not associated with the various categories and sub-categories into which the database is organized, they can create a new category in the database. Further, they can create multiple levels of categories. Further, the users can associate the topic with the new category. Thereafter, they can submit user feedback on the topic. This feedback can be viewed by other users accessing the database. These users can also submit additional feedback on the topic. Thus, the present invention allows users to share information on a wide range of topics. The users are not restricted to only submitting and sharing feedback on topics associated with a predefined list of categories and sub-categories associated with the database.

### BRIEF DESCRIPTION OF THE DRAWINGS

Before describing in detail the embodiments, in accordance with the present invention, it should be observed that these embodiments reside primarily in a method and system for managing a network-based database of user feedback. Accordingly, the system components and method steps have been represented, where appropriate, by conventional symbols in the drawings, showing only those specific details that are pertinent for an understanding of the embodiments of the present invention, so as not to obscure the disclosure with details that will be readily apparent to those of ordinary skill in the art, having the benefit of the description herein.

FIG. 1 illustrates a network where various embodiments of the present invention can be practiced;

FIG. 2 shows a block diagram of a server in accordance with an embodiment of the present invention;

FIG. 3 shows a flow diagram illustrating a method for managing a network-based database of user feedback in accordance with an embodiment of the present invention;

FIGS. 4a and 4b show a flow diagram illustrating a method for managing a network-based database of user feedback in accordance with another embodiment of the present invention; and

FIG. 5 shows an interface illustrating an application for managing a network-based database of user feedback in accordance with an embodiment of the present invention.

### DETAILED DESCRIPTION OF THE INVENTION

While the various embodiments of the invention have been illustrated and described, it will be clear that the invention is not limited to these embodiments only. Numerous modifications, changes, variations, substitutions and equivalents will be apparent to those of ordinary skill in the art, without departing from the spirit and scope of the invention, as described in the claims.

An embodiment of the present invention describes a method for managing a network-based database of user feedback. The method includes receiving a request from a user to create one or more categories in the database. Further, the method includes creating these one or more categories based on the request. The method also includes receiving a user feedback on a topic associated with the one or more categories. Furthermore, the method includes listing this user feedback under the topic in the database.

Another embodiment of the present invention also provides a server for managing a network-based database of user feedback. The server includes a receiver that is configured to receive a request from a user to create one or more categories in the database. Further, the server includes a processor that is operatively coupled to the receiver. The processor is configured to create the one or more categories based on the request. Furthermore, the processor is configured to receive a user feedback on a topic associated with the one or more categories, and also list it under the topic in the database.

Yet another embodiment of the present invention provides a computer program product for managing a network-based database of user feedback. The computer program product includes program instructions for receiving a request from users to create one or more categories in the database. Further, the computer program product includes program instructions for creating these one or more categories based on the request, as well as program instructions for receiving a user feedback on a topic associated with the one or more categories. Furthermore, the computer program product includes program instructions for listing the user feedback under the topic in the database.

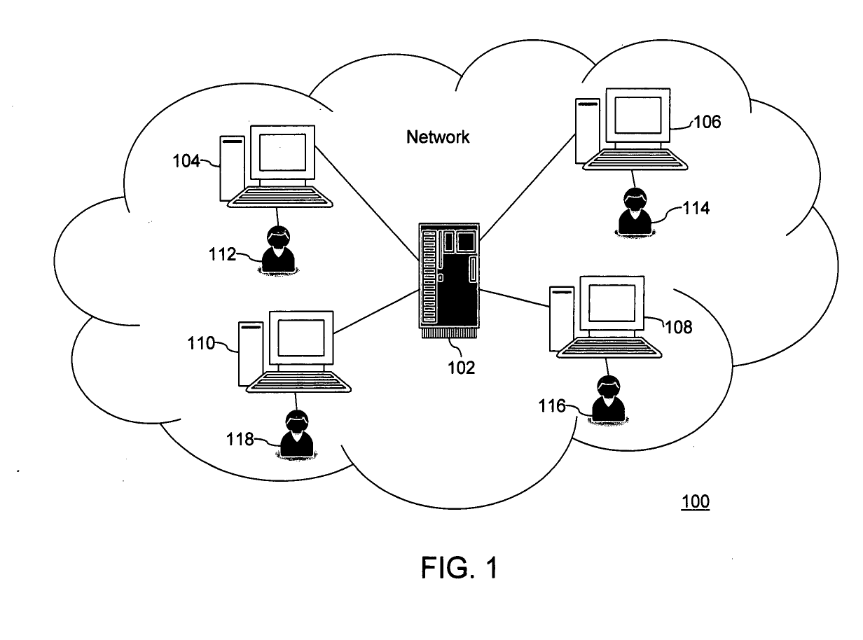

FIG. 1 illustrates a block diagram of a network 100, where various embodiments of the present invention can be practiced. Examples of the network 100 include the Internet, a wired or wireless Local Area Network (LAN), a Wide Area Network (WAN), and the like. The network 100 includes a server 102. Examples of the server 102 include Hyper Text Transfer Protocol (HTTP) servers, File Transfer Protocol (FTP) servers, and the like.

The network 100 also includes a data processing unit 104, a data processing unit 106, a data processing unit 108 and a data processing unit 110. Examples of the data processing units 104, 106, 108, and 110 include desktop computers, laptop computers, palmtops®, mobile phones, Personal Digital Assistants (PDAs), and the like. The server 102 is connected to the data processing units 104, 106, 108, and 110 through communication links. These communication links can be wired communication links and/or wireless communication links. Examples of wired communication links include optical fiber links, Ethernet cable links, and the like. Examples of wireless links include Bluetooth® links, infrared links, and the like.

The network 100 also includes a user 112, a user 114, a user 116, and a user 118 associated with the data processing units 104, 106, 108, and 110, respectively. The users 112, 114, 116, and 118 can access the server 102 via the data processing units 104, 106, 108, and 110, respectively. For example, the user 112 can send a request, to search for required information, to the server 102 via the data processing unit 104. The server 102 can process the request by searching a database associated with the server 102, and identifying the desired information, which is then made available to the data processing unit 104. Similarly, the users 114, 116, or 118 can send a request to search for information via the data processing units 106, 108, or 110, respectively. Further, the server 102 can receive requests from the users 112, 114, 116, or 118 to add new information to the database associated with the server 102. Furthermore, the server 102 can also receive requests from the users 112, 114, 116, or 118 to modify the database associated with the server 102. Although FIG. 1 is shown to include only the data processing units 104, 106, 108 and 110, it will be apparent to a person of ordinary skill in the art that the network 100 can include fewer or greater number of data processing units. Further, it will be apparent to a person of ordinary skill in the art that the network 100 can include fewer or greater number of users than shown in FIG. 1.

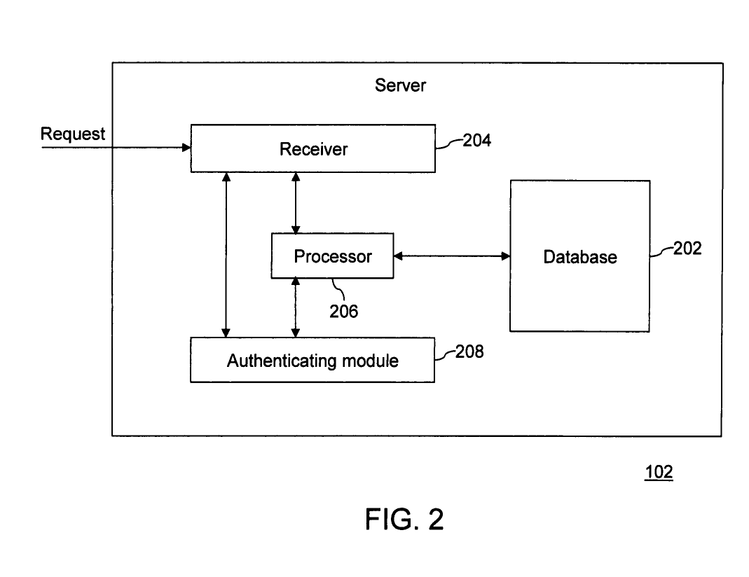

FIG. 2 illustrates a block diagram of the server 102, in accordance with an embodiment of the present invention. The server 102 includes a database 202, a receiver 204 and a processor 206. A person of ordinary skill in the art will understand that the server 102 may include additional components that are not shown here and are not pertinent to the operation of the server 102, in accordance with the inventive arrangements.

The database 202 can include a collection of user feedback on various topics. A topic is the subject matter on which user feedback is provided. For example, the database 202 can include user feedback on various restaurants. A particular restaurant from these restaurants, such as ‘The Seasons’, can be a topic on which user feedback is provided. In an embodiment, the database 202 is managed by an administrator. For example, the administrator of the database 202 can modify, delete, add, and organize the user feedback.

The collection of user feedback in the database 202 is organized into multiple categories, based on predefined criteria. The predefined criteria can include the geographical attributes of the topics, their content, and the like. A geographical attribute of a topic refers to the information related to the geographical location associated with the topic. For example, based on their geographical attribute, user feedback on restaurants located in New York City can be classified under a category named ‘New York City Restaurants’. Similarly, user feedback on restaurants located in Washington D.C. can be classified under a category named ‘Washington D.C. Restaurants’. User feedback on the restaurants belonging to each of these categories can be further organized into a next level of categories. For example, user feedback classified under the category New York City Restaurants can be classified into the next level of categories, such as ‘Chinese Restaurants’, ‘Japanese Restaurants’ and ‘That Restaurants’, based on the kind of food they serve.

Similarly, user feedback under each of these categories can be further classified into another level of categories, based on the predefined criteria. For example, user feedback under the category Chinese Restaurants can be classified into another level of categories such as ‘Deluxe Chinese Restaurants, ‘Standard Chinese Restaurants’ and ‘Economy Chinese Restaurants’, based on pricing.

In another embodiment, the database 202 can include information such as news articles, prices, product specifications, addresses, contact details, and the like, pertaining to the topics. For example, the database 202 can include the contact details of various health resorts.

The receiver 204 is configured to receive a request from a user to create one or more categories in the database 202. For example, the receiver 204 can receive a request from the user 112 to create a new category in the database 202. For instance, the new category can include user feedback on Italian restaurants located in New York City. Further, the receiver 204 can receive a request from the user 112 to create a next level of categories within the new category. These categories can include user feedback on deluxe, standard and economy Italian restaurants.

The receiver 204 is also configured to receive a request from users to create a topic associated with the one or more categories in the database 202. For example, the receiver 204 can receive a request from the user 112 to create a topic for a deluxe Italian restaurant, named ‘Montevilli Ristorante Italiano’, in the database 202. The receiver 204 is also configured to send the request to the processor 206.

The processor 206 is configured to process the request by creating the one or more categories in the database 202. For example, the processor 206 can create a new category, ‘Italian Restaurants’, within the category ‘New York City’. The category ‘Italian Restaurants’ includes user feedback on Italian restaurants located in New York City. The processor 206 can create the next level of categories, ‘Deluxe Italian Restaurants’, ‘Standard Italian Restaurants’ and ‘Economy Italian Restaurants’ within the category, ‘Italian Restaurants’. The categories ‘Deluxe Italian Restaurants’, ‘Standard Italian Restaurants’ and ‘Economy Italian Restaurants’ include user feedback on deluxe, standard and economy Italian restaurants respectively.

Further, the processor 206 is configured to link the one or more categories to the database 202 based on the predefined criteria. For example, the processor 206 can link the category, ‘Italian Restaurants’, to the database 202 under the category, ‘New York City Restaurants’, along with the other categories of ‘Chinese Restaurants’, ‘That Restaurants’, and ‘Japanese Restaurants’. Further, the processor 206 can link the categories, ‘Deluxe Italian Restaurants’, ‘Standard Italian Restaurants’ and ‘Economy Italian Restaurants’, to the database 202 by listing them under the category of ‘Italian Restaurants’.

The processor 206 is also configured to process the request by creating a topic in the database 202. For example, the processor 206 can create the topic, ‘Montevilli Ristorante Italiano’, in the database 202, based on the request. The topic, ‘Montevilli Ristorante Italiano’, can be associated with the category, ‘Deluxe Italian Restaurants’.

The processor 206 is also configured to receive feedback from a user, such as the user 112, on a topic associated with the one or more categories. For example, the processor 206 can receive user feedback on the topic, ‘Montevilli Ristorante Italiano’. Further, the processor 206 is configured to list the user feedback under the topic. For example, the processor 206 lists user feedback on ‘Montevilli Ristorante Italiano’ in the database 202, along with other user feedback on the restaurant, under the topic, ‘Montevilli Ristorante Italiano’.

In an embodiment of the invention, user feedback can be a textual review. For example, user feedback on ‘Montevilli Ristorante Italiano’ can be a short paragraph describing the service, food and ambience of the restaurant. In another embodiment, user feedback can be a rating. For example, it can be a numerical rating such as 4/5, 3/5, 9/10, and the like. In an embodiment, the user feedback can include one or more of an audio feedback, a video feedback, an image and an icon. In yet another embodiment, the user feedback can include a combination of the above-mentioned forms of feedback.

The processor 206 can also be configured to modify the one or more categories. For example, the processor 206 can merge the categories, ‘Chinese Restaurants’, ‘That Restaurants’ and ‘Japanese Restaurants’, to form a new category, ‘Oriental Restaurants’. The category, ‘Oriental Restaurants’, would include user feedback on That, Chinese and Japanese Restaurants. The processor 206 can be further configured to modify the topic. For example, if the name of the restaurant, ‘The Seasons’, is changed to ‘Seasons Café’, the processor 206 can modify the topic, by renaming it ‘Seasons Café’. In an embodiment, the processor 206 can delete the one or more categories or the topic. For example, the processor 206 can delete the category ‘That Restaurants’ from the database 202. The processor 206 can also delete the topic ‘The Seasons’ from the database 202.

The processor 206 can also be configured to delete feedback from one or more users from the database 202. The processor 206 can delete the one or more user feedback that contains objectionable or offensive content. Objectionable or offensive content can be identified based on a pre-determined list of words. For example, the processor 206 can delete a particular user feedback on the restaurant ‘The Seasons’, if that user feedback contains any of the pre-determined words. In another embodiment, the processor 206 can filter user feedback before including it in the database 202. Filtering of user feedback can be based on the pre-determined list of words. For example, the processor 206 can filter out a particular user feedback on the restaurant, ‘The Seasons’, if the user feedback contains any word from the predetermined list of words. In yet another embodiment, feedback containing offensive content is identified by manual inspection by the administrator of the database 202. In still another embodiment, the feedback containing offensive content is identified based on complaints received from one or more of the users 112, 114, 116 and 118 viewing the feedback.

In an embodiment, the server 102 can include an authenticating module 208. The authenticating module 208 is configured to authenticate the user sending the request. For example, the authenticating module 208 can authenticate the user 112 sending the request. If the user 112 is authentic, the authenticating module 208 can forward the request to the processor 206. In an embodiment, the authentication of the user can be based on a unique user identifier and password associated with the user.

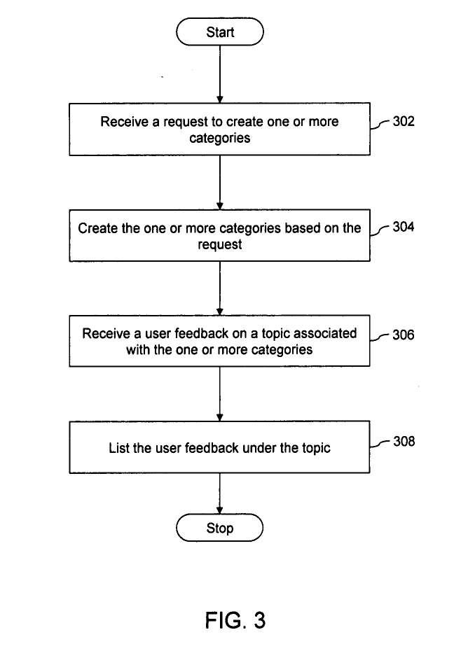

FIG. 3 shows a flow diagram illustrating a method for managing a network-based database of user feedback, in accordance with an embodiment of the present invention. To describe the method, reference will be made to FIGS. 1 and 2, although it is understood that the method can be implemented with reference to any other suitable embodiment of the present invention.

At step 302, the server 102 receives a request to create one or more categories in the database 202. This request can be initiated by a user. For example, the user 112 can send a request to the server 102, to create a new category in the database 202. The new category can include user feedback on, for example, Italian restaurants located in New York City. Further, the server 102 can receive a request from the user 112, to create a next level of categories within the new category. The next level of categories can include user feedback on, for instance, deluxe, standard and economy Italian restaurants located in New York City.

At step 304, one or more categories are created by the server 102, based on the request. For example, the server 102 can create a new category, ‘Italian Restaurants’. This category can include user feedback on Italian restaurants located in New York City. Further, the server 102 can create a next level of categories, ‘Deluxe Italian Restaurants’, ‘Standard Italian Restaurants’ and ‘Economy Italian Restaurants’, under the category of ‘Italian Restaurants’. The next level of categories, ‘Deluxe Italian Restaurants’, ‘Standard Italian Restaurants’ and ‘Economy Italian Restaurants’, can include user feedback on deluxe, standard and economy Italian restaurants, respectively.

At step 306, user feedback is received by the server 102 on a topic associated with the one or more categories. A topic is a subject matter on which feedback can be given by users. For example, a restaurant on which user feedback is received is referred to as a topic. This feedback can be provided by the users 112, 114, 116, or 118. For example, user feedback can be received from the user 112 on a particular restaurant, Montevilli Ristorante Italiano, under the category, ‘Deluxe Italian Restaurants’, in the database 202. At step 308, this feedback is listed under the topic by the server 102. For example, user feedback on Montevilli Ristorante Italiano can be listed under the topic, ‘Montevilli Ristorante Italiano’, in the database 202, along with other user feedback on Montevilli Ristorante Italiano. This feedback can be viewed by the users 114, 116 or 118 accessing the server 102.

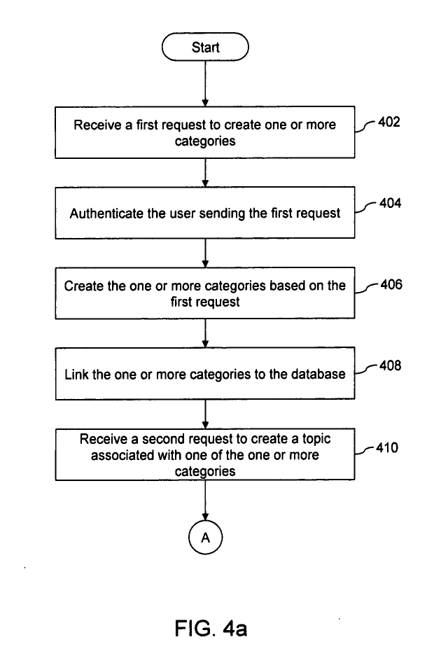

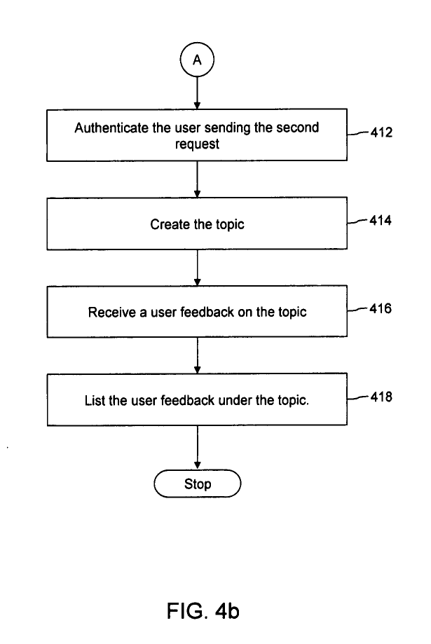

FIGS. 4a and 4b show a flow diagram illustrating a method for managing a network-based database of user feedback, in accordance with another embodiment of the present invention. To describe the method, reference is made to FIGS. 1 and 2, although it should be understood that the method can be implemented with any other suitable embodiment of the present invention. Further, the method can contain a greater or fewer numbers of steps than shown in FIGS. 4a and 4b.

At step 402, the receiver 204 receives a first request to create one or more categories in the database 202. This first request can be initiated by a user, for example, the user 112. The user 112 can send a request to the receiver 204 to create a new category in the database 202. This new category can include user feedback on, for example, Italian restaurants located in New York City. Further, the receiver 204 can receive a request from the user 112 to create a next level of categories within the new category. The next level of categories can include user feedback on deluxe, standard and economy Italian restaurants.

At step 404, the user sending the first request is authenticated by the authenticating module 208. For example, the authenticating module 208 can authenticate the user 112 sending the first request. In an embodiment, the authentication can be carried out on the basis of a unique user identifier and password associated with the user sending the request. At step 406, the one or more categories are created by the processor 206, based on the first request. For example, the processor 206 can create the new category ‘Italian Restaurants’ for user feedback on Italian restaurants in New York City. Moreover, the processor 206 can create the next level of categories, such as ‘Deluxe Italian Restaurants’, ‘Standard Italian Restaurants’ and ‘Economy Italian Restaurants’ under the category ‘Italian Restaurants’.

At step 408, the one or more categories are linked to the database 202 by the processor 206 based on the predefined criteria. For example, the processor 206 can link the category ‘Italian Restaurants’ to the database 202 by listing the category ‘Italian Restaurants’ under the category ‘New York City’ along with the other categories, such as ‘Chinese Restaurants’, ‘That Restaurants’ and ‘Japanese Restaurants’. Further, the processor 206 can link the categories created under the category ‘Italian Restaurants’ such as ‘Deluxe Italian restaurants’, ‘Standard Italian restaurants’ and ‘Economy Italian restaurants’ to the database 202 by listing them under the category ‘Italian Restaurants’.

At step 410, the receiver 204 receives a second request to create a topic associated with the one or more categories. A topic is a subject matter on which feedback can be given by users. For example, a restaurant on which user feedback is received is referred to as a topic. The second request can be initiated by a user, for example, the user 112. The user 112 can send a request to create a topic such as a deluxe Italian restaurant, Montevilli Ristorante Italiano.

At step 412, the user sending the second request is authenticated by the authenticating module 208. For example, the authenticating module 208 can authenticate the user 112 sending the second request. In an embodiment, the authentication can be carried out on the basis of a unique user identifier and password associated with the user sending the second request. If the user is authenticated by the authenticating module 208, the second request is processed by the processor 206. At step 414, the topic is created by the processor 206 based on the second request. For example, the processor 206 can create the topic ‘Montevilli Ristorante Italiano’ under the category ‘Deluxe Italian Restaurants’, in the database 202.

At step 416, user feedback on the topic is received by the processor 206. For example, the processor 206 can receive a user feedback on the restaurant Montevilli Ristorante Italiano. At step 418, this feedback is listed under the topic by the processor 206. For example, the feedback is listed under the topic ‘Montevilli Ristorante Italiano’, to the database 202, along with other user feedback on Montevilli Ristorante Italiano. This feedback can be viewed by the users 114, 116, or 118 accessing the database 202.

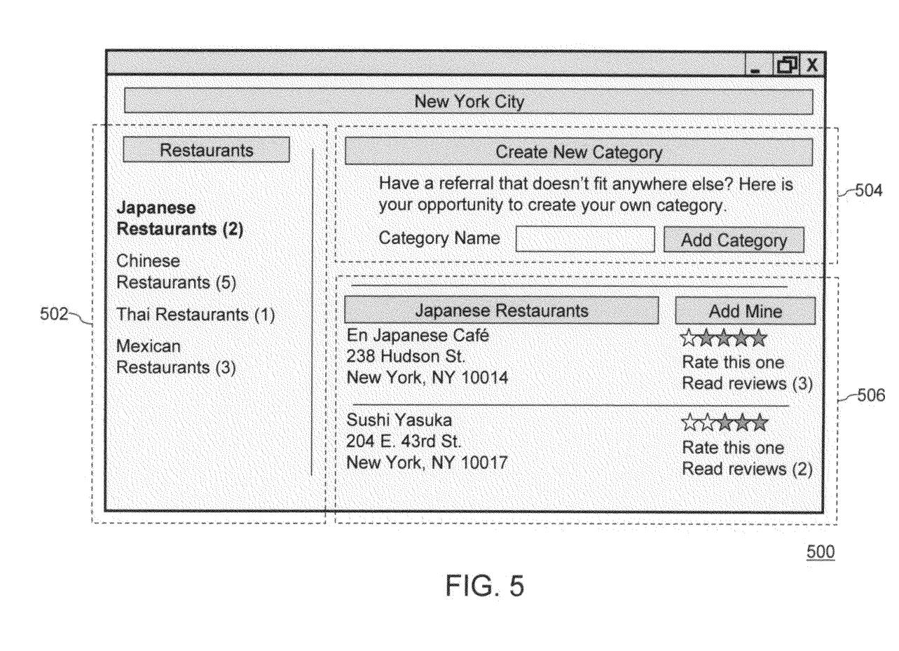

FIG. 5 is an interface 500 illustrating an application for managing a network-based database of user feedback, in accordance with an embodiment of the present invention. This application is a Graphical User Interface (GUI) that enables users to share their reviews, ratings or opinions for various products/services/topics.

The interface 500 is shown to include a block 502, a block 504 and a block 506. The block 502 is shown to display different categories of restaurants listed under the category ‘New York City’. The different categories displayed are ‘Japanese Restaurants’, Chinese Restaurants’, ‘That Restaurants’ and ‘Mexican Restaurants’. The number of restaurants under each category is indicated in parenthesis along with the category name. For example, the number ‘2’, displayed in parenthesis along with the category ‘Japanese Restaurants’ indicates that two restaurants are listed under the category ‘Japanese Restaurants’.

The block 504 in the interface 500 provides a link for users to add a new category under the category, ‘Restaurants’. The users can enter the name of the new category in a blank box displayed under the button ‘Create New Category’, and then click on the ‘Add Category’ button. For example, the user can add a new category, ‘Italian Restaurants’, to the category, ‘Restaurants’, by entering ‘Italian Restaurants’ in the blank box and then clicking on the ‘Add Category’ button. The block 506 in the interface 500 displays restaurants listed under the different categories displayed in the block 502. For example, users can view restaurants listed under the category ‘Japanese Restaurants’ by clicking on the link ‘Japanese Restaurants’ displayed in the block 502. The restaurants ‘En Japanese Café’ and ‘Sushi Yasuka’ listed under the category ‘Japanese Restaurants’ will be displayed in the block 506 by clicking on the link ‘Japanese Restaurants’. A normalized star rating, based on all the ratings given to a particular restaurant, is displayed with the name of the restaurant. Users can view all the user reviews and ratings given to the restaurants, En Japanese Café and Sushi Yasuka, by clicking on the ‘Read reviews’ link displayed with the names of the restaurants. The number in parenthesis, displayed with the ‘Read reviews’ link, indicates the number of reviews listed under each restaurant. For example, the number ‘3’, displayed in parenthesis with the restaurant En Japanese Café indicates that three user reviews are listed under the restaurant, En Japanese Café. In other words, three users have provided their ratings for the restaurant, En Japanese Café.

The interface 500 also enables a user to add a new restaurant under the category ‘Japanese Restaurants’ by clicking on the ‘Add mine’ button displayed with the name of the category ‘Japanese Restaurants’ on the block 506 of the interface 500. Further, the user can submit reviews and ratings on the restaurant, En Japanese Café, by clicking on the ‘Rate this one’ link displayed with the name of the restaurant.

As described above, the present invention provides users with a method for managing a network-based database of user feedback. This database is organized into various categories. If the topic on which the user desires to submit feedback is not associated with the categories into which the database is organized, the user can create a new category in the database. Further, the user can create multiple levels of categories and associate the topic with the new category. Furthermore, the user can submit feedback on the topic. This feedback can be viewed by other users accessing the database. The other users can also submit additional feedback on the topic.

Thus, the present invention enables users to submit and share their feedback on any topic with other users. The users can create categories, subcategories, and topics based on their choice. Thereby, the invention provides users with an organized platform to share their feedback on a wide variety of subjects of their choice. The users are not just passive receptors of the information made available by the administrator of the database, but are active participants in generating and sharing information. Hence, the invention provides the users the flexibility to control the content and organization of the database.

The method and system for managing a network-based database of user feedback, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention.

The computer system comprises a computer, an input device, a display unit and the Internet. The computer comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, and the like. Further, the storage device can be other similar means for loading computer programs or other instructions into the computer system.

The computer system executes a set of instructions that are stored in one or more storage elements to process input data. The storage elements may also hold data or other information, as desired. The storage elements may be in the form of an information source or a physical memory element present in the processing machine. Exemplary storage elements include a hard disk, a DRAM, an SRAM and an EPROM. The storage elements may be external to the computer system and connected to or inserted into it, to be downloaded at or prior to the time of use. Examples of such external computer program products include computer-readable storage mediums such as CD-ROMS, flash chips, floppy disks, and the like.

The set of instructions may include various commands that instruct the processing machine to perform specific tasks such as the steps constituting the method of the present invention. The set of instructions may be in the form of a software program. The software may be in various forms such as system software or application software. Further, the software may be in the form of a collection of separate programs, a program module with a larger program, or a portion of a program module. The software may also include modular programming in the form of object-oriented programming. The software program containing the set of instructions can be embedded in a computer program product for use with a computer, the computer program product comprising a computer-usable medium with a computer-readable program code embodied therein. Processing of input data by the processing machine may be in response to users' commands, to the results of previous processing, or to a request made by another processing machine.

The modules described herein may include processors and program instructions that implement the functions of the modules described herein. Some or all the functions can be implemented by a state machine that has no stored program instructions, or in one or more application-specific integrated circuits (ASICs), in which each function or some combinations of certain of the functions are implemented as custom logic.

While the various embodiments of the invention have been illustrated and described, it will be clear that the invention is not limited only to these embodiments. Numerous modifications, changes, variations, substitutions and equivalents will be apparent to those of ordinary skill in the art, without departing from the spirit and scope of the invention, as described in the claims.

What is claimed is:

1. A method for managing a network-based database of user feedback, the method comprising:
receiving a request from a user for creating one or more categories;
creating the one or more categories based on the request;
receiving a user feedback on a topic, wherein the topic is associated with one of the one or more categories; and
listing the user feedback under the topic.

2. The method as recited in claim 1 further comprising creating the topic, wherein the topic is created based on a request received from a user for creating the topic.

3. The method as recited in claim 1 further comprising linking the one or more categories to the database based on a predefined criteria.

4. The method as recited in claim 3, wherein the predefined criteria is based on the content of the one or more categories.

5. The method as recited in claim 3, wherein the predefined criteria is based on one or more geographical attributes of the topic.

6. The method as recited in claim 1 further comprising authenticating the user to modify the database.

7. The method as recited in claim 1, wherein the user feedback is at least one of a textual review, a rating, an audio feedback, a video feedback, an image, and an icon.

8. The method as recited in claim 1 further comprising modifying at least one of the one or more categories and the topic.

9. The method as recited in claim 1 further comprising deleting the user feedback.

10. The method as recited in claim 1 further comprising filtering the user feedback prior to listing the user feedback under the topic.

11. A server for managing a database of user feedback, the server comprising:
a receiver configured to receive a request from a user for creating one or more categories; and
a processor operatively coupled to the receiver, wherein the processor is configured to:
create the one or more categories;
receive user feedback on a topic, wherein the topic is associated with one of the one or more categories; and
list the user feedback under the topic.

12. The server as recited in claim 11, wherein the processor is further configured to link the one or more categories to the database based on a predefined criteria.

13. The server as recited in claim 12, wherein the predefined criteria is based on the content of the one or more categories.

14. The server as recited in claim 12, wherein the predefined criteria is based on one or more geographical attributes of the topic.

15. The server as recited in claim 11, wherein the processor is further configured to delete the user feedback.

16. The server as recited in claim 11, wherein the processor is further configured to filter the user feedback.

17. The server as recited in claim 11 further comprising an authenticating module for authenticating the user to modify the database.

18. A method for managing a network-based database of user feedback present at a server, the database being organized into a plurality of categories, the method at the server comprising:
receiving a first request from a user for creating one or more categories;
creating the one or more categories based on the first request;
receiving a second request for creating a topic, wherein the topic is associated with one of the one or more categories;
creating the topic based on the second request;
receiving user feedback on the topic; and
listing the user feedback under the topic.

19. The method as recited in claim 18 further comprising linking the one or more categories to the database based on a predefined criteria.

20. The method as recited in claim 19, wherein the predefined criteria is based on the content of the one or more categories.

21. The method as recited in claim 19, wherein the predefined criteria is based on one or more geographical attributes of the topic.

22. The method as recited in claim 18 further comprising authenticating the user to modify the database.

23. The method as recited in claim 18, wherein the user feedback is at least one of a textual review, a rating, an audio feedback, a video feedback, an image, and an icon.

24. The method as recited in claim 18 further comprising modifying at least one of the one or more categories and the topic.

25. The method as recited in claim 18 further comprising deleting the user feedback.

26. The method as recited in claim 18 further comprising filtering the user feedback prior to listing the user feedback under the topic.

27. A computer program product for managing a network-based database of user feedback, the computer program product comprising a computer readable medium comprising:
program instructions for receiving a request from a user for creating one or more categories;
program instructions for creating the one or more categories based on the request;
program instructions for receiving user feedback on a topic, wherein the topic is associated with one of the one or more categories; and
program instructions for listing the user feedback under the topic.
